(19) United States
(12) Patent Application Publication
(10) Pub. No.: US 2005/0036036 A1
(43) Pub. Date: Feb. 17, 2005

(54) Camera control apparatus and method

(76) Inventors: Neil James Stevenson, Leamington Spa (GB); Jonathan Richard Raphael Martin, Olney (GB)

Correspondence Address: BARNES & THORNBURG, P.O. BOX 2786, CHICAGO, IL, 60690-2786, US

(21) Appl. No.: 10/484,758

(22) PCT Filed: Jul. 25, 2002
(86) PCT No.: PCT/GB02/03414

(30) Foreign Application Priority Data
Jul. 25, 2001 (GB) 0118083.5
Mar. 12, 2002 (GB) 0205770.1

(51) Int. Cl. H04N 5/232

(52) U.S. Cl. 348/211.99; 348/211.9; 348/211.7; 348/211.8

(57) ABSTRACT

A camera control apparats (10) comprises a control device (14) for controlling the zoom pan and tilt conditions of a camera. Data relating to the positioning of the camera in pan, tilt and zoom is transmitted to the control means and the control means converts the data into a value in a co-ordinate system, for example (3D) polar co-ordinates. The camera may be controlled and directed by pointing a pointer to an area in the image displayed whereby in response to selection of a point on a display the control means pans and/or tilts the camera so that the image viewed by the camera is centred substantially on the point selected. Still further, an area of the screen can be selected, for example by tracking and dropping a box using a mouse pointer on a computer screen and the control means is arranged to pan and tilt the camera so the image is centred on the centre of the selected area and zoomed so that the selected area becomes substantially the entire image viewed by the camera. In a further aspect a multiple camera control apparatus is provided in which a plurality of cameras may be controlled using the aforesaid control apparatus and the multiple camera control apparatus includes data relating to the location of the cameras with reference to the site plan so that multiple cameras can be co-ordinated to provide better image data, blind spot illumination and “hand over” functionality. Still further a security apparatus is provided in which a camera views an image and the security apparatus includes image processing means and data relating to the site viewed by the camera so as to determine the location and size of an object viewed.

The invention relates to a camera control apparatus and method and particularly to, although not exclusively limited to, a cameral control apparatus and method for remote control of a closed circuit camera.

Existing remote camera control systems are commonly referred to as “telemetry control” systems. Generally, they only provide a straightforward remote control function, enabling a camera to be panned or tilted about an axis and then zoomed to the required level of zoom. Such controls can be effected by virtue of a set of arrow keys to control panning and/or tilting of a camera and a further set to control the zoom level. Thus, if a controller presses a “right” arrow key, the camera will pan right while the operator is pressing the key. These systems do not provide a feedback function. In other words, it is not possible remotely to determine the position of the camera or the level of zoom.

Some camera robotics devices, for example a motorised zoom lens or pan/tilt head, do provide feedback signals to the telemetry controller. Such feedback signals enable the controller to recall positions from a set of stored preset positions. Preset storage is usually carried out at the time of installation by pointing the camera at the scene to be stored and then asking the telemetry controller to record the feedback positions of each axis in memory, for example in the permanent memory of a computer controller.

However, both of those above systems have distinct limitations. Zooming and panning or tilting simultaneously are either not possible or can lead to the operator becoming disorientated. In addition, the number of preset positions, where presets are possible, is limited by memory capacity and by the additional cost involved in setting up a camera with multiple preset positions.

It is an object of the invention to provide an improved camera control apparatus and method.

According to a first aspect of the invention there is provided a camera control apparatus comprising control means for controlling one of a zoom, pan or tilt condition of a camera, feedback means which feeds back a signal regarding the position or state of a camera with reference to said condition and conversion means to convert the feedback signal into a value in a co-ordinate system.

In that way, the operator of the camera control apparatus is aware at all times of the orientation and state of the camera in the co-ordinate system. For example, 3D polar co-ordinates may be provided for the pan and tilt settings referenced to “horizontal, due north”.

In another embodiment, two of the zoom, pan or tilt conditions are controlled by the control means and signals according to each are fed back to the conversion means to convert the signals into references in a co-ordinate system. Most preferably all of the zoom, pan and tilt conditions of a camera are controlled by the control means. In that case signals relating to all three conditions are fed back to the conversion means to convert the feedback signals into three references in a co-ordinate system.

Where the pan or tilt conditions are fed back the co-ordinate system is preferably a 3D polar co-ordinate system. Where the zoom condition is fed back, the co-ordinate system preferably relates to angular field of view. Alternatively, the zoom condition may be expressed as a percentage between 0% (minimum zoom) and 100% (maximum zoom).

In addition to zoom, pan or tilt conditions, the feedback means can feed back a signal relating to the focus of the camera to place that in a co-ordinate system.

In a preferred embodiment, adjustment of the lens focus axis can be effected such that control means is able to take into account the focus shift due to a change in the wavelength of the scene illumination. In current CCTV systems, this shift is particularly noticeable when infrared scene illumination is provided for overnight operation. The significantly longer wavelength of this light causes the focus position apparently to move closer to the camera, and this is exacerbated by the fact that under such lighting conditions the lens iris is usually fully open, resulting in a reduced depth of field, hence a greater required accuracy in focus adjustment. In the preferred system it will be possible to define a variation in the actual setting of the lens to correspond to the desired object distance from the lens under varying lighting conditions.

In a further preferred embodiment, adjustment of the lens focus axis can be effected such that some control means is able to take into account any focus shift required by adjustment of the zoom axis of the lens. In conventional CCTV systems it is required to ‘track’ or align a zoom lens to a particular camera during manufacture or installation. This is necessary as a zoom lens is manufactured in such a way that an image will stay in focus throughout the zoom range of the lens, provided that the cameras' image sensor is accurately positioned at a particular distance from the rear of the lens—termed the “back focus” of the lens. The tracking of a zoom lens is achieved by adjusting this distance between camera image sensor and lens rear and is a time consuming, iterative process. Furthermore, it can be necessary to readjust the back focus whenever either the camera or lens is replaced for any reason, which is an undesirable operation for a service or installation technician to perform. Furthermore, the back focus position is also dependent upon the wavelength of the scene illumination, as above. In the preferred system it is possible to calibrate any shift required in the actual focus position of the lens, caused by physical misalignment or change of illumination wavelength, such that the apparent object focus remains unchanged.

One of the problems encountered by operators of conventional telemetry control systems operating at a remote location from the camera is that the use of a restricted band width system for transmitting the data from camera to controller can cause a delay between frame updates. Consequently, that can lead to an overshoot where the frame update presented to the operator lags behind the actual camera position and camera and lens settings. In a preferred embodiment of the present invention the control apparatus includes means for determining any delay in the link between the camera and the operator and the control means varies the speed at which it alters the zoom, pan or tilt condition accordingly. In that way, the system operator is never disorientated by overshoot of the camera.

Another problem with existing systems is that it can be difficult accurately to position a camera that is heavily zoomed in. That is due to the aforementioned system delay but also because a small angular change in the orientation of the camera has a significant effect on the image viewed when heavily zoomed in. In a preferred embodiment, the present system includes means for calculating the most appropriate pan and/or tilt speed based upon the zoom setting.

In a preferred embodiment, adjustment of the pan or tilt axes of the system, preferably both, can be performed such that the effects of misalignment of the camera image sensor are eliminated under zoom movement conditions. In a perfect system, the centre of the camera image sensor is accurately aligned with the central axis of the lens system. In this way movement of the zoom will appear to take place ‘through the middle’ of the picture. However, even minor misalignment of the camera image sensor, for example +/−2% of the picture in either horizontal or vertical axis, results in the picture zooming through some point other than its middle. This appears to the user as an undesirable shift (pan or tilt) of the picture when under zoom movement. In the preferred system, this physical misalignment is converted to an angular error at the current zoom position and this error is then corrected by physical adjustment of the pan and/or tilt axes by control means whenever the zoom position is changed.

Remote viewing of live CCTV video using restricted bandwidth transmission means, such as telecommunications network has to cope with the inherent transmission delay, in addition to any image processing delay, such as compression prior to transmission and subsequent decompression to enable the image to be viewed. It is common for video transmission systems to allow an operator to select conditional refresh transmission. With conditional refresh, each frame to be transmitted is compared to the last frame which was transmitted and only those parts of the image which have changed are transmitted, usually after some data compression process. After transmission (and decompression) the image is overlaid on the previous image to update the display. In a typical CCTV application where most of the image is static, this greatly reduces the amount of data transmitted and thereby provides an enhanced frame refresh rate. This relies on the delta coding (calculation of the difference) taking less time than the difference in transmission time of a full image compared to the delta coded one. As the proportion of the image which has changed from frame to frame increases, the benefit of delta coding correspondingly reduces. At the extreme, where the entire image changes, there is no benefit of delta coding because the entire frame will need to be transmitted. Moreover, the time taken to perform the delta coding may, in these circumstances, increase the transmission delay.

In the case where the remote operator is able to control a camera's pan, tilt, zoom, focus, etc, moving the camera or altering the zoom means that, in terms of delta coding, the whole image changes. Some transmission systems try to get around this by reducing the volume of data per frame by, for example, reducing the image quality or size (transmitting only the central portion of the image) while the camera is moving or the zoom being adjusted.

Because the present apparatus provides a co-ordinate system, it is possible to use that co-ordinate system to determine changes in the image due solely to a change in the camera zoom, pan or tilt condition. For example, if the operator pans the camera one degree to the left, the image effectively “rotates” around the viewer by one degree to the right. The majority of the new image is, in fact, the old image shifted slightly to the right. The only new matter in the image would be that part of the image at the left edge of the viewed area. Using the co-ordinate system of the preset invention, a “shift factor” can be calculated due to the movement of the camera. By using the shift factor, the changes in the image viewed due solely to movement or zooming of the camera can be removed from the delta coding calculation. Thus, only changes in the image viewed need to be delta coded. According to a preferred embodiment of the invention, the apparatus comprises means for determining a shift factor due to a change in one or more of the pan, tilt or zoom conditions of the camera. Preferably, the means for determining a shift factor is arranged on the camera and the shift factor is transmitted to image processing software to enable the change of image to be calculated.

Thus, by way of the above example where the camera is panned one degree to the left, the sift factor determining means determines a shift factor which pertains to that movement. A small section at the right hand edge of the former image is eliminated and a small section at the left hand edge is new. Only that new section at the left hand edge needs to be transmitted to the image display as “new data”. Thus, only that section and any movement, for example a person moving, needs to be delta coded. Such an arrangement means that by combining the shift factor and delta coding the remaining image, the benefits of conditional refresh, in particular, higher image quality, size and frame refresh rate, can be provided in moving camera installations or in zooming cameras.

That arrangement can also be used in conjunction with image processing software to “blank out” the background of an image. In such a case only moving objects would be displayed. That is particularly helpful where a camera operator is alerted to a threat at a remote site and the operator has to ascertain quickly the nature of the threat. By eliminating the background, the operator can track moving objects and quickly identify the nature of the threat.

A major overhead of CCTV Central Monitoring Stations, particularly for outdoor sites, is responding to false alarms created by light condition changes, wind blown debris, movement of trees in the wind, wildlife, etc. A benefit could be obtained by eliminating as many of these false alarms as possible. This can be done by analyzing the speed of movement of an object through a sensors range and/or pattern of movement across a number of alarm sensors, be they passive infrared or video motion detection from the camera(s). Some existing CCTV systems use motion detection with adjustable sensitivity to try to achieve this, but because of the effects of perspective, these can only work with either fixed cameras or a movable camera where a default position effectively renders it a fixed camera for this purpose. Due to the provision of the co-ordinate system, in conjunction with a topographical image of the terrain, the size of an image can be calculated, with a view to screening out targets which are considered benign, eg not a person or a vehicle. Image processing or other aspects of the target, such as shape, can also further refine the screening of false alarms.

The present apparatus is preferably provided for remote control of a camera.

In a preferred embodiment, the apparatus comprises a display, displaying the image viewed by the camera, the apparatus controls one or both of the pan or tilt conditions of the camera, pointer means is provided on the display whereby in response to selection of a point on the display by means of the pointer, the control means controls the pan and/or tilt condition of the camera so that the image viewed by the camera is substantially centred on the point selected. Most preferably, both the pan and tilt conditions of the camera are thus controlled. For example, it may be that the camera does not have a tilt control or a pan control since the camera is only intended to move about one axis. However, it is possible that a camera will need to be rotated about two axes so as to provide a panning and tilting function.

In a further preferred embodiment, the pan, tilt and zoom conditions of a camera are controlled by the control means, the control apparatus includes a display showing the image viewed by the camera and pointer means on the display whereby the operator can select an area of the image using the pointer on the display and the control means controls the pan and tilt conditions so that the image viewed by the camera is substantially centred on the centre of the selected area and the zoom condition is controlled so that the area selected is substantially the extent of the area displayed by the camera. In other words, the camera may be zoomed out to a maximum extent as a default condition and the operator may select an area of the viewed image using the pointer, eg the top right hand quadrant of the viewed image. The camera is then controlled to pan to the right and upwardly so that the centre of the top right hand quadrant becomes the centre of the viewed image and the zoom control zooms so that the top right hand quadrant fill the display.

When the apparatus is fed back data relating to the zoom condition, that data can be used to control the lights associated with the camera. A spot light used with a wide angle view gives a small brightly lit spot in the centre of the screen surrounded by darkness, whereas a wide flood used with a zoomed in view is wastefully illuminating areas not in camera's view. Lights for CCTV cameras are often used in pairs: one wide and one narrow to cover the zoom range of the lens. The present invention can switch between the two lights according to the zoom co-ordinate. Thus only the most appropriate light will be on at any time with override for bulb failure. Used in conjunction with soft start for the bulb, this should significantly extend bulb life. Most CCTV maintenance site visits are primarily to change bulbs, so any extension of bulb life offers a major maintenance cost saving.

In a second aspect of the invention there is provided a method for controlling a camera comprising the steps of providing control means for controlling one of a zoom, pan or tilt condition of a camera, feeding back a signal from the control means regarding the position or state of the camera with reference to the condition and converting the feedback signal into a value in a co-ordinate system.

Preferably the method comprises the step of controlling all three of the zoom, pan and tilt conditions. In a preferred embodiment the method comprises the further step of determining a link delay between camera and operator and adjusting the speed at which the control means pans, tilts or zooms the camera so as to prevent overshoot of the camera. Preferably the method also includes the step of determining the zoom level of a camera and altering the zoom, pan or tilt speed of the camera so as to prevent overshoot. In a further preferred method there are provided the further steps of providing a display showing the image viewed by the camera and providing pointer means on the display, selecting a point on the display by means of the pointer and panning or tilting the camera so that the image viewed by the camera is substantially centred on the point selected on the display. In the most preferred embodiment, in addition to re-centering, the method further comprises the step of using the pointer to select an area on the screen, panning and/or tilting the camera so that the image viewed by the camera is substantially centred on the centre of the area selected on the screen becomes the centre of the image viewed by the camera and zooming the camera so that the selected area fills the image viewed by the camera.

In a preferred embodiment, the method further comprises the step of determining a shift factor of the viewed image corresponding to a change in one of the zoom, pan or tilt conditions of the camera, providing the shift factor to an image processor, delta coding the part of the viewed image not subject to the shift factor, providing the delta coding to the image processor and processing a previously viewed image with the shift factor and delta coding to create a new image.

According to a third aspect of the invention there is provided a camera control apparatus comprising control means for controlling the pan or tilt condition of a camera, a display showing the image viewed by the camera, pointer means on the display whereby in response to selection of a point on the display by means of a pointer, the control means pans the camera so that the image viewed by the camera is centred substantially on the point selected.

In a fourth aspect of the invention there is provided a camera control apparatus comprising control means for controlling the pan, tilt and zoom conditions of the camera, a display showing the image viewed by the camera, pointer means on the display whereby, in response to a selection of an area on the display by means of a pointer, the control means pans and tilts the camera so that the image viewed by the camera is centred substantially on the centre of the selected area and zooms the camera so that the selected area becomes substantially the entire image viewed by the camera.

Where the selection of an area determines the zoom control on the camera, the camera control apparatus and method preferably includes means to determine the optimum size of image displayed dependent upon the aspect ratio of the viewing area of the display. So as to fit the image best on the display.

The rapid and accurate control makes it much easier to capture facial images. The captured facial images also have a higher image quality in view of the “shift factor” transmission of data. Preferably, there is provided means to transmit facial image data to a central database whereby the facial image data can be compared against existing stored facial image data. In that way, known criminals can be identified at an early stage.

The terms “pan” and “tilt” used herein are relative terms and simply relate to rotation of the camera about transverse axes. Generally, “panning” relates to rotation of the camera about a substantially vertical axis while “tilting” relates to rotating the camera about a substantially horizontal axis. However, those definitions are not applied vigorously herein and it may be that, in some circumstances, “panning” the camera relates to rotation of the camera about a non-vertical axis and “tilting” relates to rotation of the camera about a non-horizontal axis. The relative axes between the pan and tilt need not be perpendicular, although it is envisaged that generally those axes will be perpendicular to each other.

In multiple camera installations, tracking an incident and tracking cameras on a particular location requires a considerable amount of operator skill, judgement and experience. Often, a camera which could be trained on an incident is missed because the operator is too busy tracking, a moving target for example, a shoplifter in a shopping arcade or the like.

It is an object of the present invention to provide an improved multiple camera control apparatus and method.

According to a fifth aspect of the invention, there is provided a multiple camera control apparatus comprising a plurality of cameras, each having a control apparatus as set out in the first aspect of the invention above, the multiple camera control apparatus having means for storing data regarding the location of each camera with reference to a site plan, means for receiving data from each camera relating to at least one of the zoom, pan or tilt conditions of the camera and means for controlling the cameras so as to co-ordinate the images viewed by the cameras.

For example, in a fixed camera installation where the zoom condition is remotely controlled, because the system knows the location of each camera in the installation and knows the angular field of view of each camera from the zoom feedback of that camera, the system can determine the area viewed of the site by extrapolating the camera location, zoom level and site plan. By using that data, The system can be used automatically to zoom in other cameras in the installation that have a line of site on the viewed area.

Preferably, the cameras are moving cameras in which the pan, tilt and most preferably also zoom conditions of the camera are controlled remotely by an operator. In such a case, data relating to all of the controlled conditions is passed to the multiple camera control apparatus.

Preferably, the data relating to the location of each camera comprises a three dimensional cartesian co-ordinate set. In that case, the sum can determine the three dimensional cone of view of each camera depending upon camera 3-D location, pan, tilt and zoom condition and the site map. The apparatus can thus be used automatically to train multiple cameras towards the cone of view of any particular cameras. For example, in a multiple, moving camera installation, an operator may wish to track a moving target, for example, an individual walking through a shopping mall. In such an installation there may be multiple cameras covering any one area. Relying on the operator to keep all relevant cameras trained on the individual concerned often results in images being missed. Such missed information can be crucial, for example in providing evidence in a Court case for criminal activity. However, using the present invention, the operator can concentrate on tracking the individual and the multiple camera control apparatus, using the operator controlled camera as master and the other cameras as slaves, will ensure that all available cameras are brought to bear upon the relevant area of the site.

Another application in which the multiple camera control apparatus can be used is in “hand over”, i.e. where a moving target passes from the field of view of one camera to the field of view of another, for example by walking around a corner. Due to the fact that the apparatus includes a site plan and can determine fields of view of all cameras on site, the apparatus can be arranged to train cameras in such a way to cover any possible blind spots that the primary camera may suffer.

In one embodiment, the operator may be able to select other cameras as the primary camera. In such a case, all of the other cameras are then controlled by the multiple camera control apparatus, either to train on the relevant field of view or to eliminate blind spots for the new primary camera. Alternatively, image processing means may determine which camera affords the best view of a target and switch that camera to the “primary” camera automatically.

As mentioned above, image processing can determine the likelihood of a moving object constituting a threat by analysis of speed of movement, shape, etc. In the present system, because the camera control system has the co-ordinate feedback feature, the identification of a likely threat in the camera's view can be translated into the position of that likely threat eg person or vehicle relative to a stored plan of the monitored area. This may require reference to surface co-ordinates of the terrain where a flat terrain cannot be assumed to maintain accurate positioning. As the threat moves in the camera's view the control system can track the target by maintaining it in the centre of the camera's view. The zoom control will be most preferably determined by the speed of movement of the target—eg zoom in if it stops moving to gain the most detailed image, and zoom out if the target starts to move to avoid the target being “lost”. Thus the camera system can automatically track the threat without operator intervention.

According to a sixth aspect of the invention, there is provided a camera control apparatus having a control apparatus as set out in the first above aspect, a stored plan of the area to be monitored and image processing means, whereby the threat level of an object viewed by a camera controlled by the apparatus can be determined from the image processing means and from the location of the object on the stored plan.

A site plan display can show to the remote operator the position of the threat(s) as it/they move around the site. This would helpful in for example direct responding police to the relevant area of the site.

Relating the position of a likely threat to a plan of the area also enables the neighbouring cameras to anticipate the target entering its field of view and to adopt PTZ settings to take over as the target moves from an area covered by one camera to the neighbouring one. It is extremely helpful in remotely monitored CCTV using restricted bandwidth if the anticipating camera connects to the viewer without the operator having to select it.

In monitoring public areas like shopping centres, automatic tracking would be achieved by an operator selecting the target (with eg a computer mouse) and additional characteristics such as colour pattern of clothing, hair, height or target or a vehicle colour etc in order to differentiate the target from other bystanders or vehicles. Additional image processing means may enhance the tracking capability by facial recognition or automatic number plate recognition.

Various other advantageous features can be provided including false alarm screening, camera fail alarm, intruder tracking and touch screen telemetry.

Software may be provided which analyses pulse patterns from alarm sensors (such as passive infrared sensors) to screen out false alarms and reduce time wasted at the central monitoring station. Sensors often have sensitivity settings but do not combine multiple sensors to monitor the pattern and/or speed of movement through an area. Due to the fact that camera location, orientation and zoom data can be used in conjunction with image processing means to determine approximate size of an object in view, individual sensors in the present system can determine threat level by image size and speed. Multiple such sensors increase further the ability to refine threat level determination. This feature can also be used to prioritise calls according to the predicted threat level. This feature is complemented by the association of the sensors with the site plan stored in the memory of the multiple camera control apparatus.

This feature can be further enhanced using the zoom co-ordinate which, in conjunction with image processing means can calculate the size of an object moving in the camera's view and/or its shape and/or its speed and/or its pattern of movement to assess the likelihood of it constituting an event of concern eg an intruder.

If any camera stops working, for any reason, image processing means may be provided to identify this, for example by analyzing the characteristics of the video or digital representation of a video image, which can generate an alarm. In such a case, where neighbouring cameras have been suitably located, they can be trained by the control apparatus on the stricken camera to see if it is under attack.

The touch screen telemetry feature displays a site plan, showing all relevant features, such as buildings, compounds etc. To view a particular feature, the operator simply touches it on screen and pictures from all relevant cameras will be transmitted, with the appropriate positions for that feature. The whole site can be toured in this way unlike previous systems which require numerous “pre-sets” to be established prior to use. The advantage of this over current methods is the efficiency of the use of the available transmission bandwidth.

According to a seventh aspect of the invention there is provided a security apparatus comprising a camera, image processing means for processing the image viewed by the camera and means for storing a plan of the site at which the camera is located, whereby the viewed image can be processed vis a vis the site plan so as to determine size and location of an object on the site.

Where the camera can be zoomed or tilted, the security apparatus preferably includes a camera control apparatus in accordance with the first aspect of the invention, in which the respective relevant zoom or tilt condition is fed to the image processing means to aid in processing the viewed image.

A camera control apparatus and method will now be described in detail by way of example and with reference to the accompanying drawings, in which:

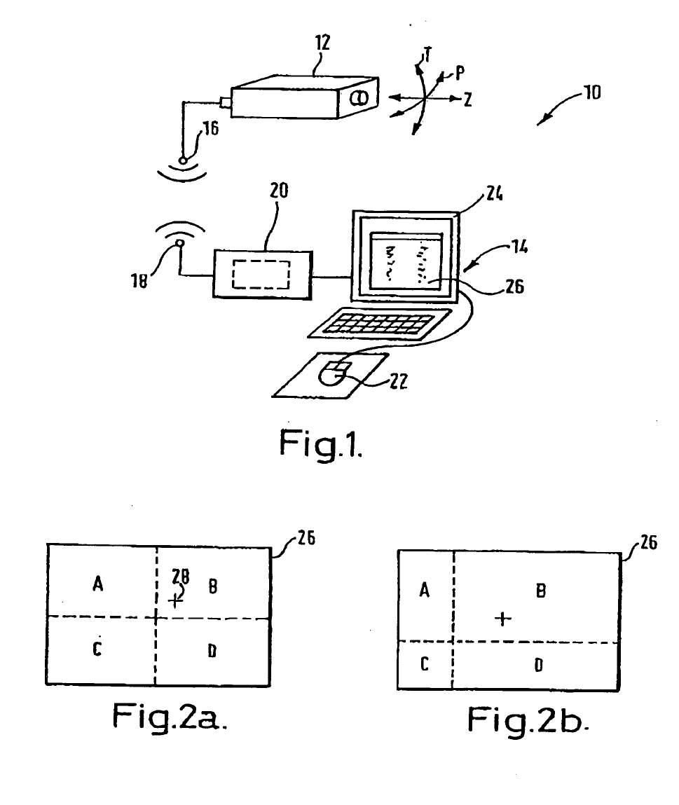

FIG. 1 is schematic diagram of a camera and camera control apparatus,

FIGS. 2a and 2b are schematic representations of an image shown on a display illustrating the camera control method in accordance with the invention,

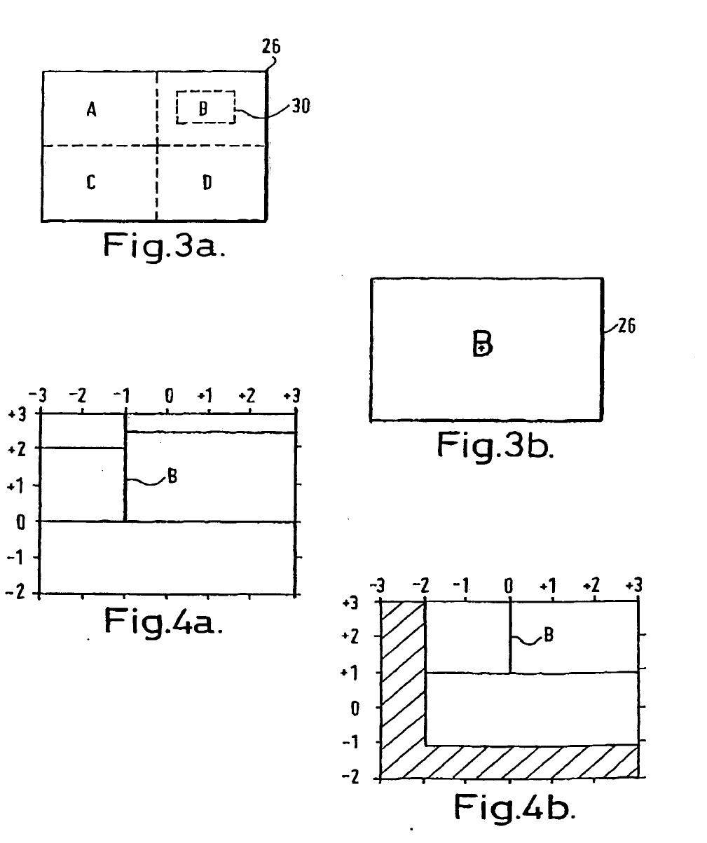

FIGS. 3a and 3b are similar representations to FIGS. 2a and 2b showing a camera control method in accordance with the invention, and

FIGS. 4a and 4b are schematic representations of an image shown on display illustrating the shift factor conditional refresh feature of the invention,

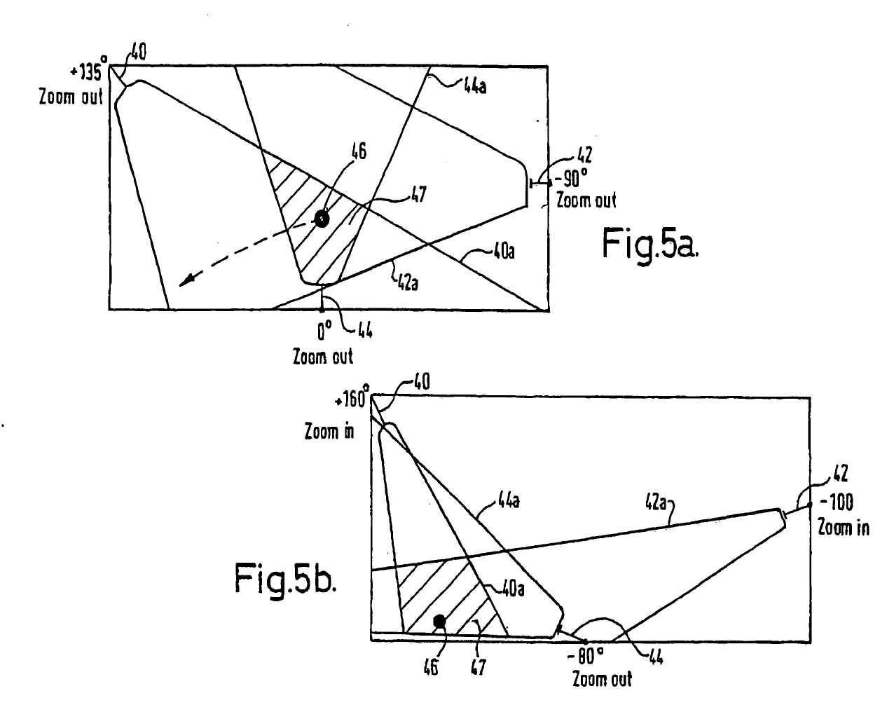

FIGS. 5a and 5b are schematic plan views of an area viewed by 3 cameras which are controlled by a multiple camera control apparatus method in accordance with the present invention, and

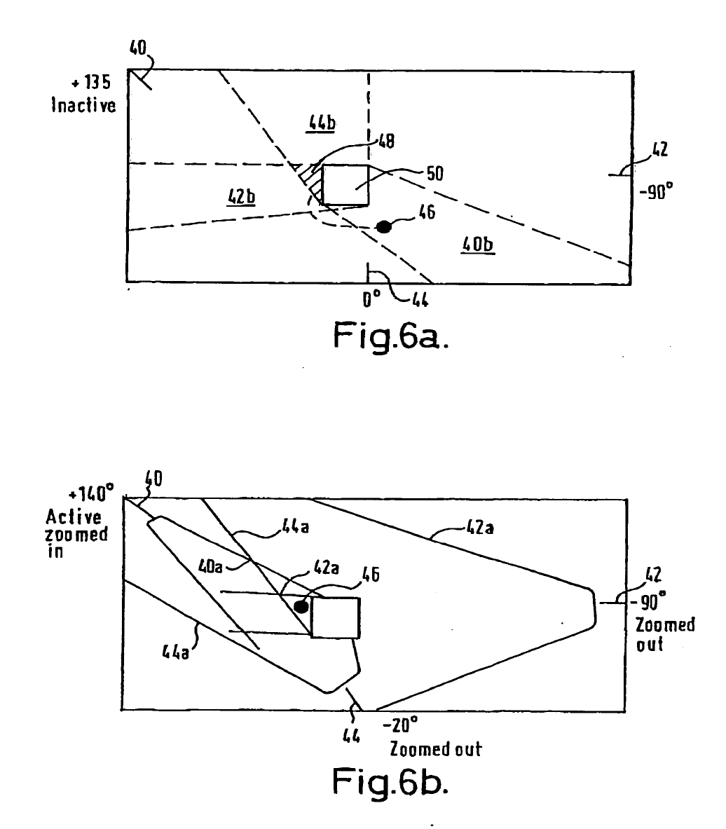

FIGS. 6a and 6b are similar to FIGS. 5a and b illustrating the effect of the multiple camera control apparatus controlling “hand-over”.

In FIG. 1 a camera control apparatus is indicated generally at 10. The apparatus comprises a camera 12, for example a closed circuit television camera. The camera 12 is mounted so that it can rotated about a vertical axis so as to pan the camera and a horizontal axis so as to tilt the camera. The camera is also provided with a zoom mechanism so that the image viewed by the camera can be enlarged. The tilt, pan and zoom functions of the camera 12 are illustrated schematically in FIG. 1 by virtue of the arrows P (pan), T (tilt) and Z (zoom). The camera 12 is driven in pan and tilt directions by respective stepper motors (not shown).

Camera 12 is connected remotely and electronically to a control device 14. The remote electronic connection may be by means of a cable connection. Alternatively, as shown in FIG. 1, the connection may be provided either by conventional telephony or mobile telephony. In the case of FIG. 1 the camera 12 includes a mobile telephone transmitter/receiver 16 which communicates with a corresponding mobile telephone transmitter/receiver 18 associated with the control apparatus 14.

The control apparatus 14 comprises, for example, a personal computer 20 including a pointer control device, such as a mouse, 22. The computer 20 further includes a monitor 24 which can display the image viewed by the camera 12 in a window 26.

In use, the camera 12 views an image at the remote camera location. The image together with data concerning positioning of the camera in tilt, pan and zoom is transmitted via the mobile telephone transmitter 16 to the mobile telephone receiver 18 at the central control centre. The data is passed to the control apparatus in the form of a computer 20. The computer 20 can convert the data relating to tilt, pan and zoom into co-ordinates in a co-ordinate system and provide that information to the user via the monitor. In particular, the computer references the state of the camera position or control to a set of calibration tables for each system component. That produces the co-ordinates required to be displayed to the operator. The image is provided through the computer 20 to the monitor 24 and is displayed within window 26 on the monitor 24.

The provision of co-ordinates provided on the display allows the user to be aware at all times of the current state and orientation of the camera. As stated above, the reduction of data to a set of co-ordinate values in relation to camera position and state allows many more preset positions to be recorded. In addition, the user can select the camera position by entering appropriate co-ordinate selections. In addition, the user has the ability to pan, tilt and zoom the camera in accordance with normal camera control systems. The tilt and pan absolute co-ordinate systems are 3D polar co-ordinates while the zoom co-ordinate system may be determined, for example, as a percentage. As mentioned above, the origin of each of those co-ordinate systems may be selected on installation. Consequently, it is not absolutely necessary to have the origin of the tilt co-ordinate system at horizontal. It may be preferable to have the origin set at 10° below the horizontal. In particular, in many public CCTV systems, the camera is arranged well above the reach of any potential interference, for example by vandals, and in order to focus on the area of concern a degree of negative tilt is required. In those circumstances, the tilt origin at a negative angle below the horizontal is to be expected. Normally, the default zoom origin will be zoomed out to the maximum extent and zoom state of the camera will be expressed as a percentage between zero, ie maximum zoom out and 100%, ie maximum zoom in.

The computer 20 preferably includes means to determine the link delay between the camera 12 and the display 26. Once the delay is determined, the pan, tilt and zoom speeds of the camera 12 are selected so as to avoid any possible problem of disorientation of the user due to overshoot of the camera as a consequence of camera movement during the link delay. A similar system is provided for zoomed in images as mentioned above.

FIG. 2a and 2b illustrates the camera control method according to the second aspect of the invention and a camera control apparatus according to the third aspect of the invention.

FIG. 2a represents the image shown within window 26 by the camera 12. For the sake of the illusion the image has been split into 4 quadrants A, B, C and D. If the user is interested in a part of the image moving towards the upper part and the right hand side of the image as viewed in FIG. 2a, the user can select a re-centering of the image by moving the pointer 28 on the screen to the position that the user determines will be the best for the centre of the image on the screen and indicating acceptance of the re-centering, probably by pressing a button on the mouse 22. Once a re-centering command has been issued by pressing the mouse button 22, the computer 20 determines the co-ordinates of the new centre and transmits an instruction via the telephone transmitter 18 and telephone receiver 16 to the camera 12. The camera 12 is then moved by means of a motorised robotic control system until it attains the new position demanded by the co-ordinates. The image that is then displayed in the window 26 can be seen in FIG. 2b where the centre of the image has moved towards the top and right of the image of FIG. 2a.

FIGS. 3a and 3b illustrate the camera control method in accordance with the second aspect of the invention and including the zoom feature and the camera control apparatus in accordance with the fourth aspect of the invention FIG. 3a is substantially identical to FIG. 2a. This time, the user, instead of selecting a re-centering of the picture by moving the pointer 28 on the screen to a new centre point and indicating acceptance by pressing a button on the mouse 22, has instead selected an area of the screen of particular interest. That area has been selected by dragging a rectangular area on the window 26 by using the mouse 22. The area selected is indicated by means of a rectangle having broken lines 30. Once the area 30 is selected, the computer 20 determines the centre of that area 30 and re-centres the image by sending the camera 12 appropriate instructions to pan and tilt to the freshly selected centre. In addition, the computer determines the level of zoom required to display just the selected area 30 within the window 26. It can be seen from FIG. 3b that the quadrant title “B” is substantially enlarged.

The computer 20 includes means for calculating the optimum zoom level given the relative aspect of ratios of the selected area and the window in which the image is to displayed. Where the user selects an area which requires the camera to zoom beyond the extent of its maximum zoom, a warning may be provided to the user and the camera will zoom in re-centred to the appropriate point to its maximum extent. The user is not limited to selecting a strict rectangular view. If the user selects an oddly shaped area or an area whose aspect ratio is s that once zoomed in extra matter would be presented in the image if an image according to the aspect ratio of window 26 was to be displayed, image processing software may be provided to edit out that extra matter so that the user is simply presented with the area that he or she selected.

FIG. 4a is a schematic representation of an image viewed by a CCTV camera at a remote location, the image being transmitted to a control site for viewing by an operator and/or recording. The camera (not shown) can be panned, tilted and zoomed.

As shown in FIG. 4a, the image viewed by the camera is displayed with co-ordinate parameters appropriate to the pan and tilt condition of the camera. In FIG. 4a those parameters have been represented numerically as −3 to +3 in the pan direction and −2 to +3 in the tilt direction. Those numerals are schematic only. In the preferred embodiment those numerals would probably be replaced by a polar value in degrees.

For the purposes of the example, the image viewed is of a street showing a boundary B between two shop fronts. It will be appreciated that the present invention can be applied in any moving camera installation.

FIG. 4b is an illustration of part of the image shown in FIG. 4a after the camera has been panned and tilted.

In conventional systems employing conditional refresh, movement of the camera would cause substantially the entire image to be delta coded and transmitted. That coding of data and the amount of data involved would cause the frame refresh rate to be diminished. Alternatively, the image size and quality would be compromised.

In the present system, when the operator causes the camera to pan, tilt or zoom, the system calculates a “shift factor” for the image due to the control input. For example, panning the camera one degree to the left effectively causes the entire image to rotate one degree to the right relative to the operator. With the present system, where the image is linked to the co-ordinate system, a shift factor can be determined and transmitted which allows the change in the image viewed due solely to camera movement to be made without having to delta code the changed image.

In the example shown in FIG. 4b, the operator has caused the camera to pan down one level and to the left one level. Thus, the system calculates a shift factor which, in effect, shifts the previously viewed image up one level and right one level in the display. Thus the upper level and the right most level fall out of the viewed area and are not transmitted. The lower most level and left most level of the new image are “new”, i.e. that part of the image was not part of the previous image so it cannot be extrapolated using the shift factor. That part of the image is transmitted as delta coded data. It can be seen from FIG. 4b that two-thirds of the new image is “old data” shifted up and right. Thus, two-thirds of the data transmission requirement are eliminated in the present example. Only one-third of the image must be delta coded and that data transmitted.

The present system significantly reduces the data transmission load in moving camera installations allowing greater frame refresh rate, larger image size and better image quality.

Optionally, the present system allows for the image to be properly refreshed from time-to-time to correct any errors due to hysteresis or other incident effects. For example, where the frame refresh rate is 10 frames per second, the system may be designed to perform a “full refresh”, in other words where the entire image is delta coded and transmitted or simply transmitted without delta coding, once every 20 frames. Although that will slow the average frame refresh rate slightly, the overall image quality is improved.

It will be appreciated that the present invention provides a substantial advantage in relation to the control of remote cameras. A conversion of the control data into a co-ordinate system allows multiple pre-set positions to be stored and allows the user to select specific positions by simply entering the co-ordinate data. In addition, the system in accordance with the present invention eliminates the possibility of overshoot due to the link delay between the remote site and the user and takes account of heavily zoomed in shots which might result in overshoot. The control method and apparatus shown in FIGS. 2 and 3 provides an advantageous form of control, especially now that many remote camera systems are monitored by displaying images in windows on a PC monitor.

As mentioned above, in another aspect of the invention a multiple camera control apparatus and method is provided and FIGS. 5a, 5b, 6a and 6b illustrate examples of the application of that control apparatus and method.

All of FIGS. 5a, 5b, 6a and 6b represent a schematic plan view of a site having 3 cameras 40, 42, 44. The site is generally rectangular and camera 40 is located in one corner of the rectangle, when viewed in plan and its rest position is to point diagonally towards the middle part of the rectangle. Camera 42 is arranged towards the centre of one short side of the rectangle pointing inwardly towards the centre thereof whilst camera 44 is located towards the centre of one long side of the rectangle pointing inwardly towards the centre thereof. A pole angular co-ordinate system is used in the figures to show the orientation of each camera. The polar co-ordinate system is arranged so as to measure plus/minus 180 degrees from “north”. Consequently, camera 40's rest position is +135 degrees, camera 42's rest position is −90 degrees and camera 44's rest position is 0 degrees.

FIG. 5a illustrates the situation when the cameras 40, 42 and 44 are in their rest position fully zoomed out. The lines 40a, 42a and 44a show the fields of view of cameras 40, 42, 44 respectively. Numeral 46 indicates a moving object, for example a person within the field of view. It will be noted that the fields of view 40a, 42a and 44a overlap so as to generate an area which all three cameras view, that area being designated reference numeral 47.

All three of the cameras 40, 42 and 44 transmit image data to a local storage facility. All three cameras 40, 42 and 44 are controlled by multiple camera apparatus (not shown) in accordance with the present invention.

As the person 46 moves across the site the operator can track the movement of the person 46 by controlling one of the cameras 40, 42, 44. The camera that is being controlled by the operator is designated the “primary camera”. Let us say that for the purposes of the example shown in FIGS. 5a and 5b that the “primary camera” is camera 40. As the person 46 moves along, that person is tracked by movement of camera 40. In FIG. 5b camera 40 has been panned through 25 degrees from its original position and the lens has been zoomed in to its maximum extent. It will be noted that the field of view of the camera 40 is considerably restricted as compared to the field of view in FIG. 5a. In addition to the provision of a plurality of cameras, each of which has a control apparatus as set out above, the multiple camera control apparatus includes location information in relation to each camera with regard to a site plan. Consequently, it is possible for the multiple camera control apparatus for the installation shown in FIGS. 5a to calculate the area that camera 40 is viewing in its field of view. That can be extrapolated from camera position in three dimensions, camera orientation and zoom state, ie angular field of view.

In FIG. 5b, because camera 40 has been rotated so as to track the movement of person 46, cameras 42 and 44 have been controlled so that they are all viewing the area of interest to the operator. That control occurs without intervention from the operator. Consequently, it can be seen that camera 42 has been instructed by the control apparatus to zoom in whilst camera 44 remains zoomed out. Camera 44 covers all of the field of view of camera 40 whilst camera 42 is zoomed in specifically to the intended target of camera 40.

Such an arrangement means that a single operator can control multiple cameras at a site simultaneously by control of a primary camera so as to provide a far better collection of images in relation to any particular event. An example of the application of such an arrangement might be in a shopping centre where a camera operator is tracking a suspicious person. By following the suspicious person with a single primary camera and using the multiple camera control apparatus to operate the other cameras, the operator can concentrate on following the individual concerned without having to worry about the quality of the image data being recorded. Any other camera in the installation which can view the field of the view of the “primary camera” can be brought to bear on that field of view thus minimizing the possibility that anything of importance might be missed. This is especially important in criminal matters where any element of doubt can be terminal to a case against a perpetrator.

Preferably the local storage facility records the entire image viewed by all of the cameras whilst the central operator will see a lower quality image due to the lower frame refresh rate required when transmitting data along telecommunications lines. However, using the refresh features described above means that the transmitted image data is improved and overall camera control is also easier. The multiple camera control apparatus includes image processing software which, in conjunction with the camera control apparatus and the “shift factor” can filter out the background view from an image and isolate only moving objects. That arrangement is extremely helpful in camera monitoring situations in which a central site monitors multiple remote camera sites. In that circumstance, various sensors may be provided at the remote camera site to trigger recording, for example a PIR sensor or other anti-burglar related equipment. In the event that a camera begins to film, the operator at the central site may be alerted and the image data from the local camera can be streamed to the central operator. By utilizing the image processing software, camera control apparatus and multiple camera control apparatus the background data can be filtered out and only moving image data be transmitted. That assists the camera operator in determining the reason for the threat alert. It also assists in tracking any potential perpetrators.

Not only is the system helpful for gathering better quality image data in relation to prosecutions, the fact that the multiple camera control apparatus can determine the field of view of each camera with relation to the site plan, the actual movement of a person who is tracked by a camera operator through a site can be recorded by virtue of tracking the intersection between the camera fields of view. For example, in FIGS. 5a and 5b the camera fields of view which intersect is crosshatched and illustrated at 47. That intersection occurs generally centrally of the rectangular site in FIG. 5a and in FIG. 5b it has moved towards the bottom left of the rectangular site. Consequently, by recording that data the movement of an individual through an area can be tracked with a considerable degree of accuracy and recorded for evidentiary purposes.

The multiple camera control apparatus can also determine, using image processing means and the information relating to camera orientation, location and zoom level the size of an object being viewed. That can aid in threat detection since the system can be programmed to activate a threat alert only on detection of objections exceeding a certain size or moving at a certain rate, or both.

In addition, with reference to FIGS. 6a and 6b, the apparatus can be used to avoid blind spots. In particular, because the apparatus includes a site plan including the location and orientation of each camera, possible blind spot hazards can be determined. One such example is shown in FIG. 6a. In FIG. 6a the camera installation arrangement is identical to that shown in FIGS. 5a and b but there is a large block 50, for example a pillar, arranged in the middle of the site. Each camera 40, 42, 44 has part of its potential field of view obscured by that pillar 50. Those areas are shown outlined in broken lines and designated 40b, 42b, and 44b. It will be noted that 42b, and 44b intersect so that there is a small area designated 48 which cannot be viewed either by camera 42 or camera 44. In the example shown, cameras 42 and 44 are viewing a person 46 moving along the site in the image shadow of the pillar 50 in relation to camera 40. Consequently, camera 40 is inactive. As the person 46 moves around the pillar 50, the person moves into the area which cannot be viewed either by camera 42 or camera 44. Normally, this situation would require the central camera operator to have a working knowledge of the site and know which camera to activate in order to view the blind spot 48. However, with the present system, that is not required since the multiple camera control apparatus can determine that a blind spot will occur for both cameras 42 and 44 and can, in turn, activate camera 40. In the example shown in FIG. 6b, the person 46 has moved in to the blind spot 48 for cameras 42 and 44 and camera 40 has been activated and zoomed in to focus on the blind spot. In that way, valuable evidential data is not missed.

That arrangement also helps in “hand-over”. Where a camera has a field of view which for example, views a corridor and the corridor has a bend, the remainder of the corridor being viewed by a second camera, the previous systems required the remote operator to know which camera to activate in order to track a person moving along the corridor and around the bend. The present system has no such requirement since the system can be programmed to “hand over” a tracked target from one camera to the next camera that would be able to view the image. For example, in the “corridor” example, the first camera would be used to track the moving target along the corridor and the multiple camera control apparatus simultaneously would control the second camera so as to view the area of the corner around which the target would move. Using the aforementioned image processing software which filters out the background image, the second camera “knows” when the moving target appears in its field of vision.

The image processing means may also be used to determine which of a series of multiple cameras trained on a target is providing the best image and may automatically switch that camera to the position of “primary” camera. In such a case, the other cameras viewing the image will be controlled by the multiple camera control apparatus to view the field of view of the new primary camera.

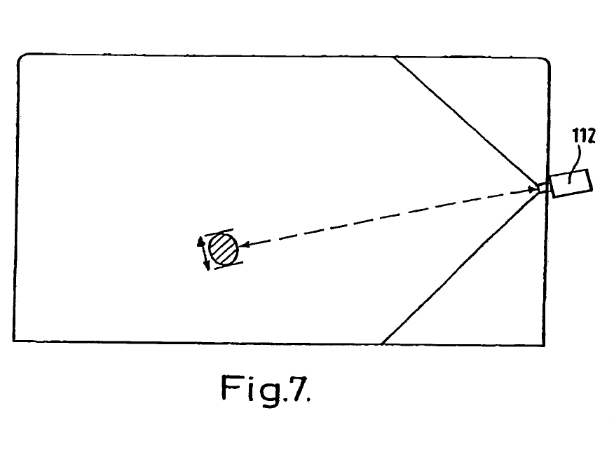

A security apparatus 100 in accordance with the seventh aspect of the invention is illustrated in FIG. 7.

Parts in FIG. 7 corresponding to parts in FIGS. 1 to 6 carry the same reference numerals prefixed with a “1”.

In FIG. 7, the security apparatus 100 comprises a camera 112 arranged to view an area. The camera 112 has no zoom, pan or tilt function. The apparatus 100 further comprises a computer 20 which processes image data viewed by the camera The computer 20 has data relating to the site viewed by the camera stored therein and image processing software.

In use, as shown in FIG. 7, the camera films an image in its field of view. The image is processed by the image processing software in the computer. Site plan data can be used further to process the image so as to determine approximate size and location of the viewed object. For example, if an assumption is made that a viewed object is likely to be a person, which assumption can be made in some installations, the image processing means can process the size of the image in the view and, using preset data relating to size of people and the known effect of perspective, can determine the distance of a viewed person from the camera

Where the nature of a viewed object can not be presumed, the image processing means can be arranged to determine the position of the base of the object in the view and from that data and site plan data determine distance from the camera. Once distance has been established, size can be determined from the image data.

Where the camera has a zoom or tilt condition, for example when heavily zoomed in or out or tilted down to view close to the camera, objects appear larger or smaller in the image. In such a case, feed back data relating to the zoom or tilt conditions is also used to process the image so as to determine position and size of object.

Multiple cameras 42 may be provided for use in the security apparatus 100.

1-42. cancelled.

43. A camera control apparatus comprising control means for controlling one of a zoom, pan or tilt condition of a camera, feedback means which feeds back a signal regarding the position or state of a camera with reference to said condition and conversion means to convert the feedback signal into a value in a co-ordinate system whereby camera position or state data is associated with image data from an image viewed by the respective camera whereby any particular part of the viewed image is associated with a corresponding particular value in the co-ordinate system.

44. A camera control apparatus according to claim 43, in which two of the zoom, pan or tilt conditions are controlled by the control means and signals according to each are fed back to the conversion means to convert the signals into references in a co-ordinate system.

45. A camera control apparatus according to claim 43, in which all of the zoom, pan and tilt conditions of a camera are controlled by the control means and signals relating to all three conditions are fed back to the conversion means to convert the feedback signals into three references in a co-ordinate system.

46. A camera control apparatus according to claim 43, in which where the pan or tilt conditions are fed back, the co-ordinate system is a 3D polar co-ordinate system.

47. A camera control apparatus according to claim 43, in which where the zoom condition is fed back, the co-ordinate system related to angular field of view.

48. A camera control apparatus according to claim 43, in which, where the zoom condition is fed back, the zoom condition is expressed as a percentage between 0% (minimum zoom) and 100% (maximum zoom).

49. A camera control apparatus according to claim 43, in which the feedback means feeds back a signal relating to the focus of a camera to place that in a co-ordinate system.

50. A camera control apparatus according to claim 43, in which means is provided for determining any delay in the link between the camera and the operator and the control means varies the speed at which it alters the zoom, pan or tilt condition accordingly.

51. A camera control apparatus according to claim 43, in which the apparatus comprises means for determining a shift factor due to a change in one or more of the pan, tilt or zoom conditions of the camera.

52. A camera control apparatus according to claim 51, in which the means for determining a shift factor is arranged on the camera and the shift factor is transmitted to image processing software to enable the change of image to be calculated.

53. A camera control apparatus according to claim 43, in which the apparatus comprises a display, displaying the image viewed by the camera, the apparatus controls on the display whereby in response to selection of a point on the display by means of the pointer, the control means controls the pan and/or tilt condition of the camera so that the image viewed by the camera is substantially centred on the point selected.

54. A camera control apparatus according to claim 53, in which both the pan and tilt conditions of the camera are thus controlled.

55. A camera control apparatus according to claim 43, in which the pan, tilt or zoom conditions of a camera are controlled by the control means and the control apparatus includes a display showing the image viewed by the camera and pointer means on the display whereby the operator can select an area of the image using the pointer on the display and the control means controls the pan and tilt conditions so that the image viewed by the camera is substantially centred on the centre of the selected area and the zoom condition is controlled so that the area selected is substantially the extent of the area display by the camera.

56. A camera control apparatus according to claim 43, in which the zoom condition of a camera is controlled by the apparatus, the control apparatus including a display showing the image viewed by the camera and pointer means on the display whereby the operator can select an area of the image using the pointer on the display and the zoom condition of the camera is controlled so that the area selected is substantially the extent display by the camera after zooming.

57. A camera control apparatus according to claim 43, in which means is provided to select appropriate illumination for the camera subject to the zoom condition.

58. A camera control apparatus according to claim 57, in which a spotlight and a wide area floodlight are provided for the camera and the means for selecting illumination switches between the spotlight and floodlight subject to the zoom condition.

59. A method for controlling a camera comprising the steps of providing control means for controlling one of a zoom, pan or tilt condition of a camera, feeding back a signal from the control means regarding the position or state of the camera with reference to the condition, converting the feedback signal into a value in a co-ordinate system, and associating the position or state data with image data from an image viewed by the camera whereby any particular part of the viewed image is associated with a corresponding particular value in a co-ordinate system.

60. A method for controlling a camera according to claim 59 in which the method comprises the step of controlling all three of the zoom, pan and tilt conditions.

61. A method for controlling a camera according to claim 59 in which the method comprises the further step of determining a link delay between the camera and operator and adjusting the speed at which the control means pans, tilts or zooms the camera so as to prevent overshoot of the camera.

62. A method for controlling a camera according to claim 59 in which the method also includes the step of determining the zoom level of a camera and altering the zoom, pan or tilt speed of the camera so as to prevent overshoot.

63. A method for controlling the camera according to claim 59 in which there are provided the further steps of providing a display showing the image viewed by the camera and providing pointer means on the display, selecting a point on the display by means of the pointer and panning or tilting the camera so that the image viewed by the camera is substantially centred on the point selected on the display.

64. A method for controlling a camera according to claim 63 in which, in addition to re-centering, the method further comprises the step of using the pointer to select an area on the screen, panning and/or tilting the camera so that the image viewed by the camera is substantially centred on the centre of the area selected on the screen becomes the centre of the image viewed by the camera and zooming the camera so that the selected area fills the image viewed by the camera.

65. A method for controlling a camera according to claim 59 further comprising the step of controlling the zoom condition of the camera and using a pointer on a display to select an area of an image, and controlling the zoom condition of the area so that the selected area substantially fills the image viewed by the camera.

66. A method for controlling a camera according to claim 59 in which the method further comprises the step of determining a shift factor of the viewed image corresponding to a change of one of the zoom, pan or tilt conditions of the camera, providing the shift factor to an image process, delta coding the part of the viewed image not subject to the shift factor, providing the delta coding to the image processor and processing a previously viewed image with the shift factor and delta coding to create a new image.

67. A camera control apparatus comprising control means for controlling the pan or tilt condition of a camera, a display showing the image viewed by the camera, pointer means on the display whereby in response to selection of a point on the display by means of a pointer, the control means pans the camera so that the image viewed by the camera is centred and substantially on the point selection.

68. A camera control apparatus comprising control means for controlling the pan, tilt and zoom conditions of the camera, a display showing the image viewed by the camera, pointer means on the display whereby, in response to a selection of an area on the display by means of a pointer, the control means pans and tilts the camera so that the image viewed by the camera is centred substantially on the centre of the selected area and zooms the camera so that the selected area becomes substantially the entire image viewed by the camera.

69. A camera control apparatus comprising control means for controlling the zoom condition of the camera, a display showing the image viewed by the camera, pointer means on the display, whereby, in response to a selection of an area on the display by means of the pointer, the control means zooms the camera so that the selected area becomes substantially the entire image viewed by the camera.

70. A camera control apparatus or method according to claim 64 in which the camera control apparatus and method preferably includes means to determine the optimum size of image displayed dependent upon the aspect ration of the viewing area of the display, so as to fit the image best on the display.

71. A multiple camera control apparatus comprising a plurality of cameras, each having a control apparatus according to claim 43, the multiple camera control apparatus having means for storing data regarding the location of each camera with reference to a site plan, means for receiving data from each camera relating to at least one of the zoom, pan or tilt conditions of the camera and means for controlling the cameras so as to co-ordinate the images viewed by the cameras.

72. A multiple camera control apparatus according to claim 71 in which the data relating to the location of each camera comprises a three dimensional cartesian co-ordinate set whereby the system can determine the three dimensional cone of view of each camera depending upon camera 3-D location, pan, tilt and zoom condition and the site map.

73. A multiple camera control apparatus according to claim 71 in which the apparatus manages handover of a tracked subject from one camera to another.

74. A multiple camera control apparatus according to claim 71 in which the apparatus is arranged to control cameras to eliminate blind spots.

75. A multiple camera control apparatus according to claim 71 in which the operator can select a primary camera and other camera(s) are then controlled by the multiple camera control apparatus, either to train on the relevant field of view or to eliminate blind spots for the primary camera.

76. A multiple camera control apparatus according to claim 71 in which image processing means determine which camera affords the best view of a target and switches that camera to the primary cameras.

77. A multiple camera control apparatus according to claim 71 in which means is provided which analyses pulse patterns from alarm sensors (such as passive infrared sensors) to screen out false alarms.

78. A multiple camera control apparatus according to claim 71 in which image processing means is provided to identify camera failure which can generate an alarm.

79. A multiple camera control apparatus according to claim 78 in which, where neighboring cameras have been suitably located, they are automatically trained by the control apparatus on the stricken camera to see if it is under attack.

80. A multiple camera control apparatus according to claim 71 in which touch screen telemetry is provided which displays a site plan and to view a particular feature, the operator touches it on screen and pictures from all relevant cameras will be transmitted, with the appropriate positions for that feature.

81. A security apparatus comprising a camera, image processing means for processing the image viewed by the camera and means for storing a plan of the site at which the camera is located, whereby the viewed image can be processed vis a vis the site plan so as to determine size and location of an object on the site.

82. A security apparatus according to claim 81 in which the security apparatus includes a camera control apparatus having control means for controlling one of a zoom, pan or tilt condition of a camera, feedback means which feeds back a signal regarding a position or state of a camera with reference to said condition and conversion means to convert the feedback signal into a value in a co-ordinate system whereby camera position or state data is associated with image data from an image viewed by the respective camera whereby any particular part of the viewed image is associated with a corresponding particular value in the co-ordinate system, in which the respective relevant zoom or tilt condition is fed to the image processing means to aid in processing the viewed image.

83. A camera control apparatus according to claim 43 in which an image processor is provided to determine from the viewed image whether a viewed object constitutes a threat.

84. A camera control apparatus according to claim 43 in which the camera position or state data is embedded in the image data.

85. A multiple camera control apparatus according to claim 71 in which the control apparatus includes control means for controlling one of a zoom, pan or tilt condition of a camera, feedback means which feeds back a signal regarding a position or state of a camera with reference to said condition and conversion means to convert the feedback signal into a value in a co-ordinate system whereby camera position or state data is associated with image data from an image viewed by the respective camera whereby any particular part of the viewed image is associated with a corresponding particular value in the co-ordinate system, and an image processor is provided to determine from the viewed image whether a viewed object constitutes a threat.

86. A method of controlling a camera according to claim 59 in which the camera position or state data is embedded in the image data.
